(19) United States
(12) Patent Application Publication
(10) Pub. No.: US 2017/0262110 A1
(43) Pub. Date: Sep. 14, 2017

(54) HYBRID FORCE SENSOR

(71) Applicant: Synaptics Incorporated, San Jose, CA (US)

(72) Inventors: Igor Polishchuk, Fremont, CA (US); Petr Shepelev, Campbell, CA (US)

(21) Appl. No.: 15/066,088

(22) Filed: Mar. 10, 2016

(51) Int. Cl. G06F 3/041

(52) U.S. Cl. CPC G06F 3/0414

(57) ABSTRACT

An input device includes an input surface, electrodes configured to sense input objects in a sensing region overlapping the input surface, a compressible layer, and a display separated from a housing by the compressible layer. The input device further includes at least one force sensing electrodes configured to sense force applied to the input surface. The compressible layer has local material densities that are proportional to the bending properties of the display in response to force applied to the input surface.

### FIELD

This invention generally relates to electronic devices.

### BACKGROUND

Input devices, including proximity sensor devices (also commonly called touchpads or touch sensor devices), are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, one or more embodiments relate to an input device that includes an input surface, electrodes configured to sense input objects in a sensing region overlapping the input surface, a compressible layer, and a display separated from a housing by the compressible layer. The input device further includes at least one force sensing electrodes configured to sense force applied to the input surface. The compressible layer has local material densities that are proportional to the bending properties of the display in response to force applied to the input surface.

In general, in one aspect, one or more embodiments relate to an electronic system that includes a housing and an input device. The input device includes an input surface, electrodes configured to sense input objects in a sensing region overlapping the input surface, a compressible layer, and a display separated from the housing by the compressible layer. The input device further includes force sensing electrodes configured to sense a deflection of the display in response to force applied to the input surface. The compressible layer has local material densities that are inversely proportional to the bending properties of the display in response to force applied to the input surface.

Other aspects of the invention will be apparent from the following description and the appended claims.

### BRIEF DESCRIPTION OF DRAWINGS

One or more embodiments of the invention will hereinafter be described in conjunction with the appended drawings, where like designations denote like elements.

FIGS. 1, 2, 3, 4, 5, 6, 7, 8, 9, 10, 11, and 12 are diagrams of example systems that includes an input device in accordance with one or more embodiments of the invention.

FIG. 13 is a flowchart in accordance with one or more embodiments of the invention.

### DETAILED DESCRIPTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present invention provide input devices and methods that facilitate improved usability. One or more embodiments are directed to an input device for a force sensor. The input device includes a compressible layer that has local material densities that are proportional to the bending properties of the display of the input device. The bending of the display results from a force on an input surface of the display. By making the local material densities of the compressible layer proportional to the bending properties, one or more embodiments create, within a pre-defined threshold degree of accuracy, a uniform force response across the display. Thus, the one or more force electrodes that may measure the amount of force on the input surface have at least approximately uniform measurements to the same amount of force regardless of the location of the force in accordance with one or more embodiments of the invention.

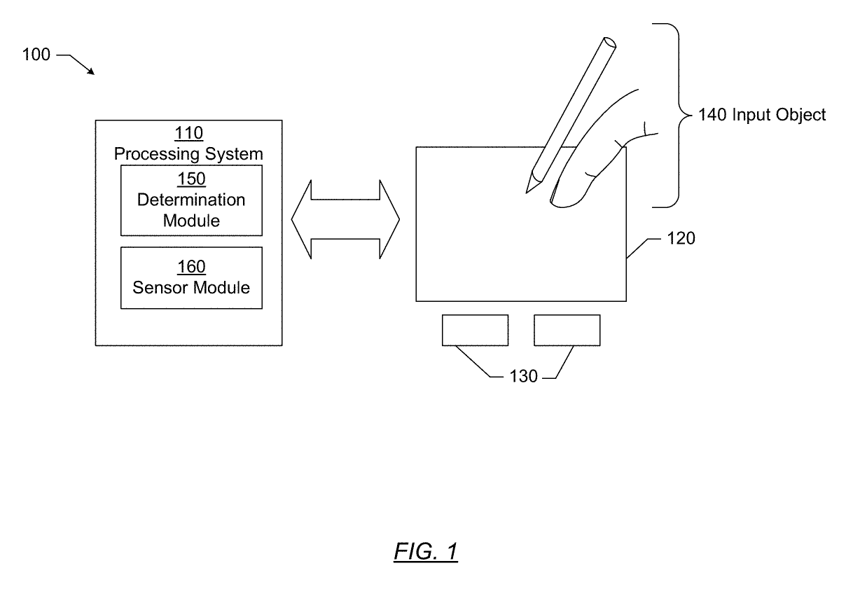

Turning now to the figures, FIGS. 1-12 are diagrams of example systems that includes an input device in accordance with one or more embodiments of the invention. The Figures are not drawn to scale. In particular, the relative sizes of the various components may change without departing from the scope of the invention. Further, although FIGS. 1-12 show a certain configuration of components, other configurations may exist without departing from the invention. For example, various components may be combined into a single component, a single component may be separated into multiple components, some components may not exist in an implementation, and other variations may occur.

FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) may be part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects may exist in the sensing region (120). Further, which particular input objects are in the sensing region may change over the course of one or more gestures. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher-dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may be a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of, or all of, one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

It should be understood that while many embodiments of the invention are described in the context of a fully-functioning apparatus, the mechanisms of the present invention are capable of being distributed as a program product (e.g., software) in a variety of forms. For example, the mechanisms of the present invention may be implemented and distributed as a software program on information-bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

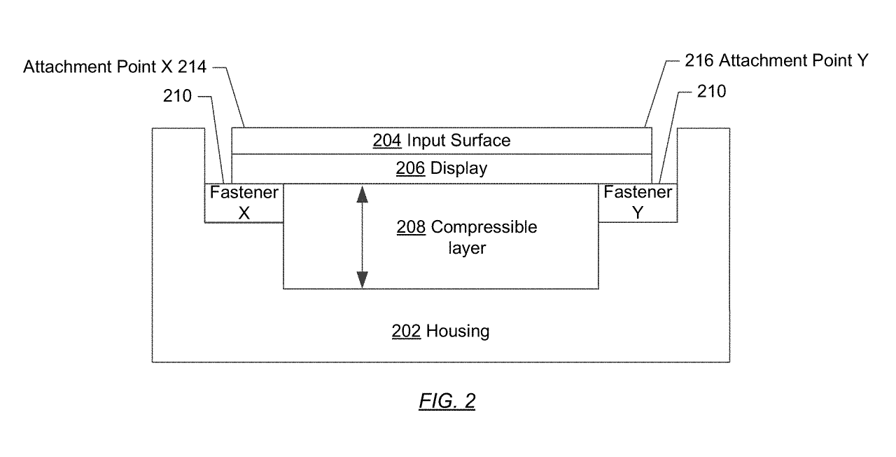

FIG. 2 shows a block diagram of an example system in accordance with one or more embodiments of the invention. In particular, FIG. 2 shows a cross section view of an electronic system (200) having an input device in accordance with one or more embodiments of the invention. The electronic system may be a smart phone, a tablet computing device, a touchscreen, a computing device with a touchpad, or other device. As shown in FIG. 2, the electronic system (200) includes at least a housing (202) and an input device. The electronic system (200) may include additional components, such as a central processing unit, memory, controllers, and other components that are not shown.

The housing (202) may be metal, plastic, other material, or a combination of materials. The housing (202) may be referred to as the frame of the electronic system (200) and may hold the input device.

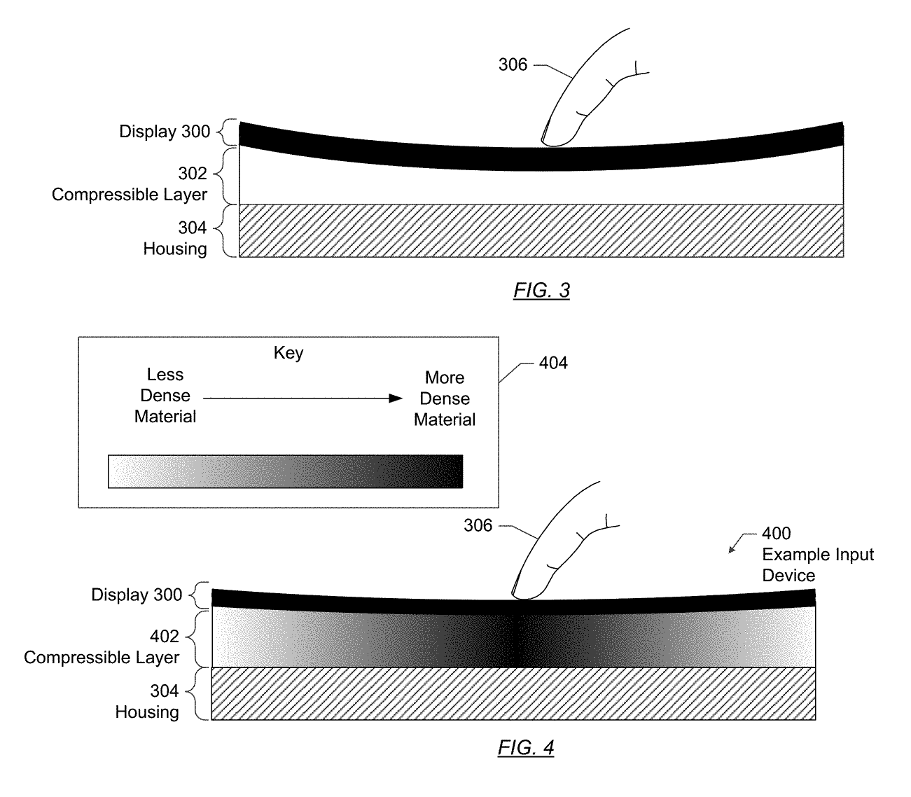

The input device includes an input surface (204), a display (206), and a compressible layer (208). The input surface (204) is the surface of the input device that may be touched by an input object. For example, the input surface may be glass or other material. The display (206) is a physical device that is configured to present visual information to a user. The input surface (204) and display (206) have bending properties that define the amount of bending by the input surface (204) and display (206) in response to force at various locations along input surface. In other words, the bending properties of the input surface (204) and display (206) is the amount of bend of the input surface (204) and display (206) when subjected to an external force onto the input surface (204) and display (206). The input surface (204) and display (206) may be treated as having a single bending properties or distinct bending properties. Although FIG. 3 shows a distinct input surface (204) and display (206), the input surface may be an uppermost part of the display.

One or more fasteners (e.g., fastener X (210), fastener Y (212)) may connect the input surface (204) and the display (206) to the housing (202) at attachment points (e.g., attachment point X (214), attachment point Y (216)). For example, the fastener may be an adhesive (e.g., weld, solder, cement, glue), crimping, a mounting bracket or other hardware connector, or other type of fastener. The attachment points (e.g., attachment point X (214), attachment point Y (216)) are the points at which the fastener connects the input surface (204) and display (206) to the housing (202). For example, the attachment points may be around the edges of the input surface and/or the display. Other attachment points may exist without departing from the scope of the invention. The fastener may affect the bending properties of the of the input surface (204) and display (206). In other words, amount of bend may change depending on the type of fastener used and the location of the attachment points. The bending properties are discussed in additional detail with reference to FIG. 3.

Continuing with FIG. 2, the compressible layer (208) is a layer of the input device that is configured to compress at least vertically in response to force applied to the input surface (204). In particular, the compressible layer may include one or more compressible materials. For example, the compressible layer (208) may include foam, air gap, rubber, or other compressible material. The compressible layer (208) is described in additional detail with reference to FIG. 4.

Continuing with FIG. 2, the input device may further include sensor electrodes (not shown). The sensor electrodes may include one or more touch electrodes and one or more force electrodes. The touch electrodes are configured to detect the presence of input object on or above the input surface. In other words, if the sensor electrodes are capacitive electrodes, the capacitance measured using the touch electrodes is affected by the presence of at least one input object. The force electrodes are electrodes that are configured to sense the amount of force applied by at least one input object. For example, the capacitance measured by the force electrode is affected by the amount of force applied by an input object on the input surface. The force electrodes may be the same electrodes as the touch electrodes. Further, the force and/or touch electrodes may be the same electrodes used for the display updating.

In one or more embodiments of the invention, the capacitance measured by the force electrode(s) is affected by the amount of vertical compression of the compressible layer. In other words, a force electrode measures the amount of compression response of the compressible layer. The compression response may also be referred to as the conductive response, which is provided by the compression of the compressible layer. Various force sensing technologies having various configurations of force electrodes may be used. For example, the force sensing may be based on mutual capacitance or absolute capacitance sensing. The force electrodes may be above, below, and/or in the middle of the compressible payer in accordance with one or more embodiments of the invention. The following are some examples of configurations of force electrodes.

By way of a first example, a force electrode may be above or within a top section of the compressible layer, at least the section of the housing below the compressible layer may include conductive material. In the example, when the compressible layer is compressed and the force electrode is driven with a sensing signal, the resulting signal includes the effects of the decreased distance to the housing. A similar effect may be achieved by putting the one or more force electrodes within a lower section or underneath the compressible layer and having a conductive material above the compressible layer. By way of another example, a force electrode may be above the compressible layer and a force electrode may be below the compressible layer. In the example, mutual capacitive measurements acquired between the two electrodes identifies the distance between the two electrodes, and thus, the amount of compression of the compressible layer. Based on the amount of compression, a determination may be made as to the amount of force applied to the input surface. In general, almost any force sensing technology may be used in one or more embodiments of the invention.

Turning to FIG. 3, FIG. 3 shows a diagram of a system in accordance with one or more embodiments of the invention. In particular, FIG. 3 shows a cross section view of a system without including a compressible layer that complies with one or more embodiments of the invention. Similar to FIG. 2, the system includes a display (300), compressible layer (302), and housing (304). In FIG. 3, a user applies a force (e.g., through input object (306)) to the input surface (not specifically shown) causing the display (300) to bend and the compressible layer (302) to compress. Because of the attachment of the input surface and the display to the housing, the amount of bending of the display at a location on the input surface is related to the distance from the attachment points to the location. For example, if the attachment points are around the edges of the input surface, then the display (300) may deflect less around the edges of the display (300) and deflect more towards the center of the display. In other words, the bending properties may radiate inward toward the middle, whereby less bending is around the edges and more bending occurs toward middle when an equal amount of force is applied. In some instances, where additional or different attachment point(s) exists or other effects exist, the bending properties are irregular. For example, the bending properties that are accounted for by a compressible layer may include the effects of apertures in the compressible layer to account for electrical and other connectors through the compressible layer that support the sensors and display.

One or more embodiments of the invention counteract the bending properties with a compressible layer that has local densities, which are proportional to the bending properties of the display. Thus, one or more embodiments provide a uniform compression response to equal amounts of force regardless of the location on the display. By providing uniform compression response, one or more embodiments normalize any calculations of force across the input surface.

FIG. 4 shows a cross section view of an example input device (400) with a compressible layer (402) in accordance with one or more embodiments of the invention. As shown in FIG. 4 using the key (404) for the compressible layer (402), the compressible layer has varying local densities to provide the uniform compression response. The compression response may be an electric response and/or a bending response.

For the purpose of the example of FIG. 4 consider the scenario in which the compressible layer only accounts for the attachment points being at the edge of the input surface. In such a scenario, the denser material is located in the middle of the input device and less dense material is located toward the edges. The change in density is progressive to counteract the progressive change in bending properties. Thus, if input object (306) applies an equal amount of force to the center of the input surface and, subsequently, the display (300) in FIG. 3, the amount of compression of the compressible layer is less in FIG. 4 than in FIG. 3. Moreover, within a pre-defined degree of accuracy, the bending response of the display and amount of compression of the compressible layer is made more uniform across the display of FIG. 4. The pre-defined threshold is dependent on factors, such as the margin of error allowed for a particular input device.

As discussed above, the compression response is made more uniform by varying the local densities proportional to the bending properties of the display. A local density is a density of material within a size window, rather than considering the entire capacitive sensor or an individual pinpoint location. In particular, every contiguous region of a size defined by the size window has an equal compression response with-in the pre-defined threshold. For example, the size window may be three or six pixels, the size of an average human finger, or another size.

Various techniques may be used to vary the density of the compressible layer. For example, the density may be defined by macro-apertures, micro-apertures, height of compressible material, varying the type of compressible material to vary the dielectric constant of the compressible material, other physical property of the compressible layer, or a combination of techniques.

By way of an example, the compressible layer may be partially or completely formed of foam having apertures that include a less dense material, such as air. The apertures may be cavities that increase in number and/or size in an inversely proportional relationship to the bending properties of the display. Thus, as a region of the display increases in bending response, the number of cavities in the compressible material beneath the display decreases to provide more support for the display.

By way of another example, various compressible materials may be combined to create material having a changing density of electric properties. In other words, the dielectric constant of the compressible material(s) may change proportionally with the bending properties of the display. In other words, in the case of the embodiment shown in FIG. 4, the varying dielectric constant means that even though a greater distance between the force sensor and the corresponding conductive layer may exist at the edges than the middle of the display, the capacitive response (e.g., value of measurements acquired) may be made more uniform.

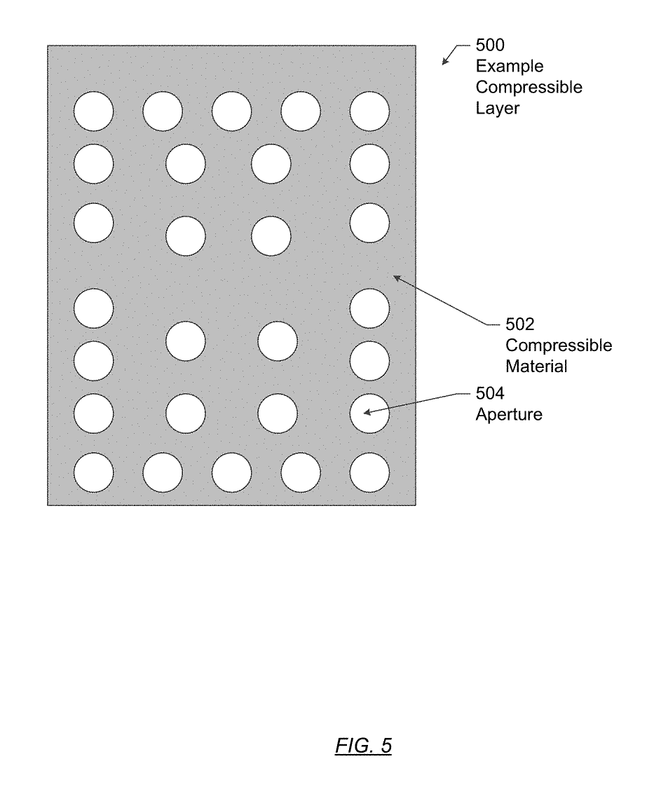

FIGS. 5-11 provide additional examples of input devices in accordance with one or more embodiments of the invention. Turning to FIG. 5, FIG. 5 shows a top down view of an example compressible layer (500). In the example of FIG. 5, the compressible layer includes compressible material (502) having macro-size apertures (504). As shown in FIG. 5, the edges of the compressible layer (500) have more apertures (504) than the center of the compressible layer (500). Because of the decrease in the number of apertures, the density of the compressible material increases away from the edges. The apertures may correspond to air gap or other material that is less dense than the compressible material.

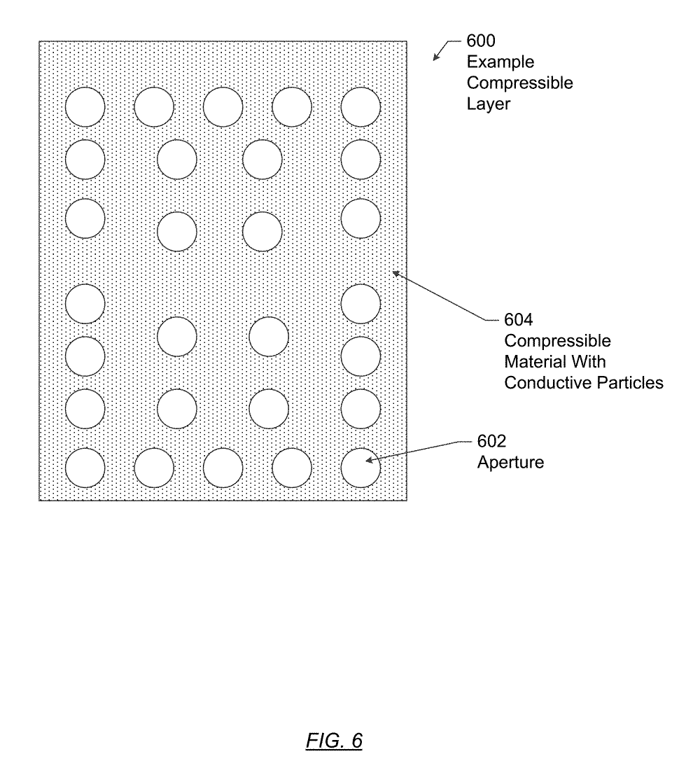

Turning to the example compressible layer (600) of FIG. 6, in some embodiments, depending on the size and type of the apertures (602) and the type of material(s) used for the compressible layer (600) zones of varying conductivity may be formed. Thus, the local conductive response at the apertures may be less than that of the compressible material even though the amount of bending of the display is the same. In other words, the apertures may provide for less conductivity than the compressible material. The compressible material may include conductive particles (604) in accordance with one or more embodiments of the invention. In other words, the existence of the conductive particles increases the conductivity of the compressible material. The amount of the increase is the same, within a threshold degree of accuracy, to equalize the local conductivity of the compressible material with the apertures. By way of another example, the compressible material may include force sensing resistors to increase the conductivity of the compressible material.

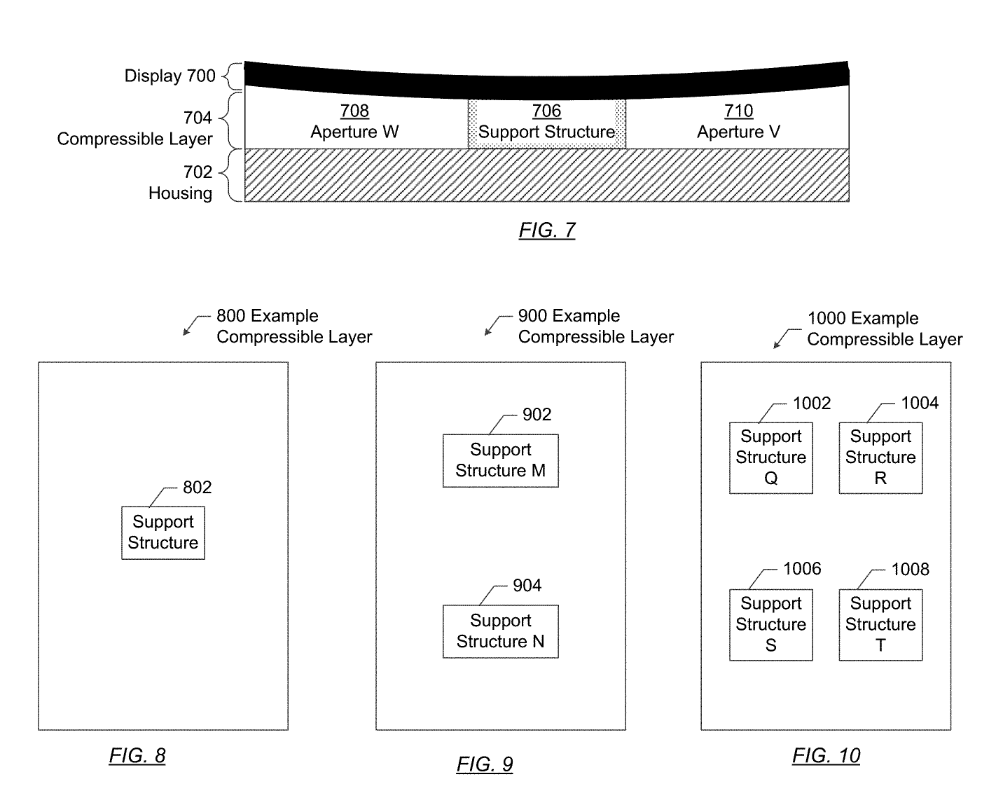

FIGS. 7-10 show another set of examples in accordance with one or more embodiments of the invention. In the examples shown in FIGS. 7-10, the amount of the compressible layer that is aperture is greater than the amount of the compressible layer that is conductive material. In other words, as shown in the example cross section view of FIG. 7, interposed between the display (700) and the housing (702) is a compressible layer (704) having one or more support structures (706) of compressible material. Apertures (e.g., aperture W (708), aperture V (710)) may surround the support structure(s). The size, shape, and number of support structures may vary between embodiments of the invention and may depend on the bending properties of the display (700). For example, FIG. 8 shows an example compressible layer (800) with a single support structure (802) in the middle of the compressible layer. By way of another example, FIG. 9 shows another example of a compressible layer (900) with two support structures (e.g., support structure M (902), support structure N (904)) that are vertically aligned and evenly spaced. By way of another example, FIG. 10 shows another example of a compressible layer (1000) with four support structures (e.g., support structure Q (1002), support structure R (1004), support structure S (1006), support structure T (1008)) that are distributed throughout the compressible layer to provide a more uniform bending response to the bending properties of the display.

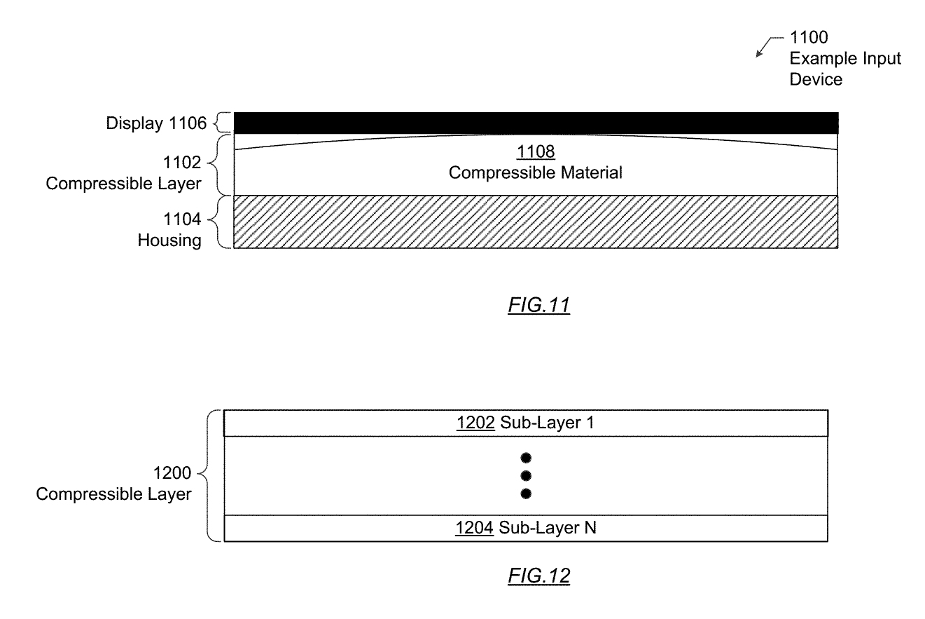

FIG. 11 shows another example cross section view of an input device (1100) in accordance with one or more embodiments of the invention. In the example in FIG. 11, a compressible layer (1102) is interposed between a housing (1104) and display (1106). As shown in FIG. 11, the compressible layer (1102) includes compressible material (1108) of varying height to have a density of the compressible material proportional to the bending properties of the display. Thus, the compressible material provides greater support toward the middle of the display in the example. Although FIG. 11 shows the compressible material as having a greater height in the middle, the variation in the height may change depending on the bending properties of the display. Further, the apertures in the compressible material (1108) may be air or other material.

FIG. 12 shows an example of a compressible layer (1200) in accordance with one or more embodiments of the invention. In the example shown in FIG. 12, the compressible layer includes multiple sub-layers (e.g., sub-layer 1 (1202), sub-layer N (1204)). Each sub-layer may correspond to a different type of material and/or different distribution of a physical and/or electrical property of the compressible material(s). The aggregate of the sub-layers may provide a more uniform compression response to the bending properties of the display.

Although FIGS. 4-12 separately discloses several different example embodiments of the invention, various examples in FIGS. 4-12 may be combined to form different embodiments. By way of an example combination, foam may be used in addition to the apertures described in FIG. 5. By way of another example combination, various compressible materials may be combined with multiple sub-layers, apertures, whereby the total material has varying height in accordance with one or more embodiments of the invention. Accordingly, any and all combinations of the examples are contemplated herein.

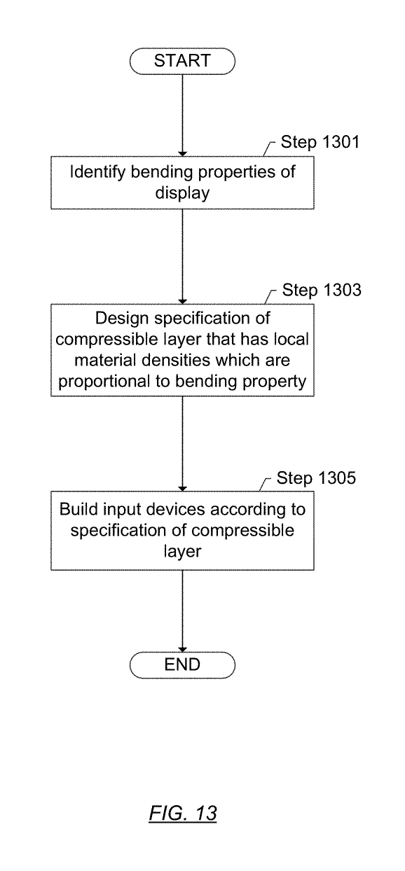

FIG. 13 shows an example flowchart in accordance with one or more embodiments of the invention for constructing an input device in accordance with one or more embodiments of the invention. In Step 1301, the bending properties of the display are identified in accordance with one or more embodiments of the invention. Identifying the bending properties of the display may be performed by testing the display by applying equal amounts of force to different locations on the input surface and obtaining capacitive readings from the force sensing electrodes. Other techniques for determining the bending properties may be used without departing from the scope of the invention.

In Step 1303, a specification of the compressible layer is designed, where the compressible layer has local material densities, which are proportional to the bending properties in accordance with one or more embodiments of the invention. The specification of the compressible layer may be designed using techniques described herein to counteract the bending properties. Using the techniques and based on economic considerations, a specification of the compressible layer may be designed.

In Step 1305, input devices are built according to the compressible layer in accordance with one or more embodiments of the invention. In other words, the specification is used to build multiple input devices as defined by the compressible layer for the input devices. FIG. 13 is only an example of a technique to manufacture input devices using one or more embodiments of the invention. Other techniques may be used without departing from the scope of the invention.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. An input device comprising:
an input surface;
a plurality of electrodes configured to sense input objects in a sensing region overlapping the input surface;
a compressible layer;
a display separated from a housing by the compressible layer; and
at least one force sensing electrodes configured to sense force applied to the input surface,
wherein the compressible layer has local material densities that are proportional to the bending properties of the display in response to force applied to the input surface.

2. The input device of claim 1, wherein the at least force sensing electrodes is located in the compressible layer.

3. The input device of claim 1, wherein the local material densities are defined by a plurality of apertures in a compressible material.

4. The input device of claim 1, wherein the local material densities are defined by a plurality of individual compressible support structures.

5. The input device of claim 1, wherein the local material densities are set, in part, to account for apertures for connectors.

6. The input device of claim 1, wherein the local material densities of the compressible material has uniformity in bending response of the display within a pre-defined threshold degree of accuracy.

7. The input device of claim 1, wherein the local material densities are defined by a non-uniform height of a compressible material in the compressible layer.

8. The input device of claim 1, wherein the local material densities are defined by a non-uniform dielectric constant for the compressible material.

9. The input device of claim 1, wherein the at least one force sensing electrode is further configured to update the display.

10. The input device of claim 1, wherein the compression of the compressible layer changes the effective dielectric constant between the at least one electrode and the housing.

11. The input device of claim 1, wherein the compressible layer comprises a plurality of force sensing resistors.

12. The input device of claim 11, wherein the compressible layer comprises a plurality of apertures and a plurality of non-aperture locations, and wherein the plurality of force sensing resistors are located in the plurality of non-aperture locations.

13. An electronic system comprising:
a housing; and
an input device comprising:
an input surface;
a plurality of electrodes configured to sense input objects in a sensing region overlapping the input surface;
a compressible layer;
a display separated from the housing by the compressible layer; and
a plurality of force sensing electrodes configured to sense a deflection of the display in response to force applied to the input surface, and
wherein the compressible layer has local material densities that are inversely proportional to the bending properties of the display in response to force applied to the input surface.

14. The electronic system of claim 13, wherein the local material densities are defined by a plurality of apertures in a compressible material.

15. The electronic system of claim 13, wherein the local material densities are defined by a plurality of individual compressible support structures.

16. The electronic system of claim 13, wherein the local material densities are set, in part, to account for apertures for connectors.

17. The electronic system of claim 13, wherein the local material densities of the compressible material has uniformity in bending response of the display within a pre-defined threshold degree of accuracy.

18. The electronic system of claim 13, wherein the local material densities are defined by a non-uniform height of a compressible material in the compressible layer.

19. The electronic system of claim 13, wherein the local material densities are defined by a non-uniform dielectric constant for the compressible material.

20. The electronic system of claim 13, wherein the compressible layer comprises a plurality of force sensing resistors.
